(19) United States
(12) Patent Application Publication
(10) Pub. No.: US 2023/0294105 A1
(43) Pub. Date: Sep. 21, 2023

(54) Solid-State Stripper Mechanism and System for Separating and Destroying Functionality of Data-Bearing Components from Solid-State PCB Devices.

(71) Applicant: Sepehr Rajaie, Pataskala, OH (US)

(72) Inventor: Sepehr Rajaie, Pataskala, OH (US)

(21) Appl. No.: 17/695,834

(22) Filed: Mar. 16, 2022

(51) Int. Cl. B02C 18/00

(52) U.S. Cl. CPC B02C 18/0007; B02C 2018/0069

(57) ABSTRACT

The present invention is a Solid-State Stripper Mechanism provides reconciliation and tracking with unique identification tags using a secure and proprietary database, separation, channeling, and collection of data-bearing components from solid-state PCBs, destruction by reducing data-bearing components to 2 mm particle size or smaller rendering the data unusable, use of a screening system to ensure accurate particle size, an internal particle collection system, an air filtration system to preserve air quality where it is located, and collection of solid-state PCBs with unique identification tags after separation of the data-bearing components for secure containment until verification.

### CROSS-REFERENCES TO RELATED APPLICATIONS (IF ANY)

Not Applicable

### BACKGROUND

### 1. Field of the Invention

The present invention relates to a device and system for destroying the functionality of data bearing components of solid-state printed circuit board (PCB) data bearing devices.

### 2. Description of Prior Art

Solid-state printed circuit board (PCB) data-bearing devices that eventually fail or are decommissioned are separated from the host server or array or other computer device and need to have the functionality of the solid-state PCB data-bearing components destroyed so that the data is no longer usable. This process must be verified to meet cyber security regulations.

Other systems may not provide reconciliation and tracking with unique identification tags using a secure and proprietary database. Other systems may not provide separation, channeling, and collection of data-bearing components from solid-state PCBs. Other systems may not provide destruction by reducing data-bearing components to 2 mm particle size or smaller rendering the data unusable. Other systems may not provide use of a screening system to ensure accurate particle size. Other systems may not provide an internal particle collection system. Other systems may not provide air filtration system to preserve air quality where it is located. Other systems may not include secure containment of non-shredded solid-state PCBs after separation and destruction of their data-bearing components until verification. Other systems may not be time and energy efficient. Other systems may not promote efficient recycling processes with less intermixing of components' raw material. Other machines in the industry are large machines that grind the data bearing components and the high quantity of mass of non-data bearing fiberglass and metal enclosures of the solid-state PCBs. Other machines may not be portable since they may weigh thousands of pounds.

Other systems may not be intended for use within the customer's secure datacenter or enterprise facility. Other systems may not be adaptable for changes in characteristics of solid-state devices. Other systems may not be adaptable for changes in cybersecurity regulations for data destruction.

There is still room for improvement in the art.

### SUMMARY OF THE INVENTION

The present invention is a Solid-State Stripper Mechanism that provides reconciliation and tracking with unique identification tags using a secure and proprietary database, separation, channeling, and collection of data-bearing components from solid-state PCBs, destruction by reducing data-bearing components to 2 mm particle size or smaller rendering the data unusable, use of a screening system to ensure accurate particle size, an internal particle collection system, and air filtration system to preserve air quality where it is located.

The Solid-State Stripper Mechanism includes secure containment of non-shredded solid-state PCBs after separation and destruction of their data-bearing components until verification. This Solid-State Stripper Mechanism is time and energy efficient while promoting efficient recycling processes with less intermixing of components' raw material. (Note: Data-bearing components on the solid-state printed circuit boards are a fraction of the solid-state PCB data-bearing devices weight, so the 2 mm or smaller particles are not mixed with other non-data bearing raw materials). This Solid-State Stripper Mechanism is portable, intended for use within the customer's secure datacenter or enterprise facility, and adaptable for changes in characteristics of solid-state devices and changes in cybersecurity regulations for data destruction. This Solid-State Stripper Mechanism is lighter than other units in the industry, which weigh thousands of pounds since they also reduce the non-data bearing materials to 2 mm particle size.

It is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a diagram of some of the components of the invention.

### DESCRIPTION OF THE PREFERRED EMBODIMENT

There are a number of significant design features and improvements incorporated within the invention.

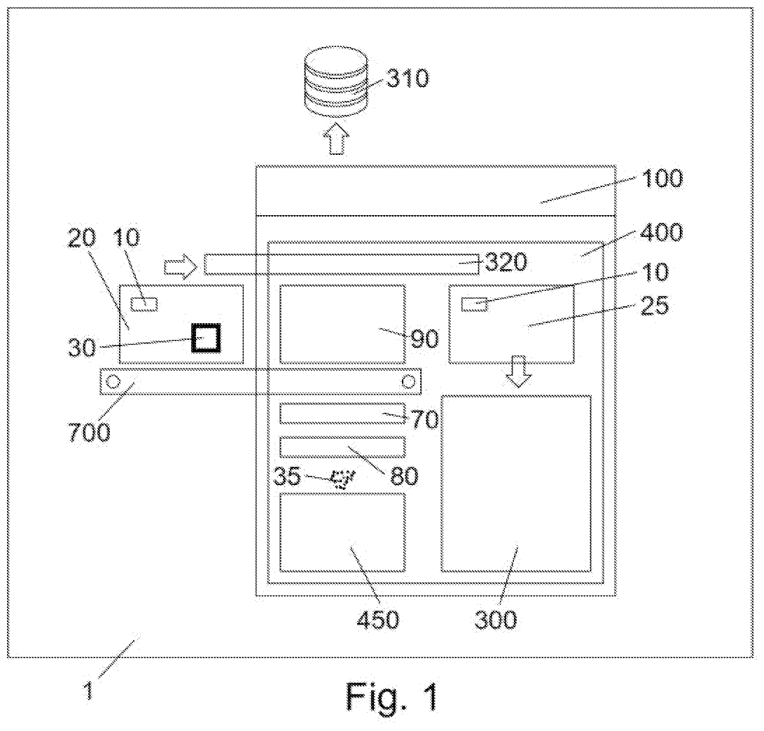

As shown in FIGS. 1, the present invention is a device and system for separating and destroying the functionality of data bearing components from solid-state PCB devices.

As stated above, solid-state printed circuit board (PCB) data-bearing devices 20 eventually fail or are decommissioned are separated from the host server or array or other computer device and need to have the functionality of the solid-state PCB data-bearing components 30 destroyed so that the data is no longer usable. This process must be verified to meet cyber security regulations. The current invention solves this problem.

The Solid-State Stripper Mechanism 1 provides reconciliation and tracking with unique identification tags 10 using a secure and proprietary database 310, channeling 700, separation 90, destruction by the grinder 70 reducing data-bearing components 30 to 2 mm particle size or smaller particles 35 rendering data unusable, use of a screening system 80 to ensure accurate particle size, an internal particle collection system 450, and air filtration system 400 to preserve air quality where it is located. The collection of solid-state PCBs after separation of the data-bearing components will then be stored as non-shredded solid-state PCBs 25 with unique identification tag 10 in system 300 for secure containment until verification.

The Solid-State Stripper Mechanism 1 includes secure containment of non-shredded solid-state PCBs 25 with unique identification tags 10 after separation and destruction of data-bearing components which have become particles 35 until verification. The Solid-State Stripper Mechanism 1 is time and energy efficient while promoting efficient recycling processes with less intermixing of components' raw material. The Solid-State Stripper Mechanism 1 is portable.

The Mechanism 1 is portable, intended for use within the customer's secure datacenter or enterprise facility, and adaptable for changes in characteristics of solid-state devices and changes in cybersecurity regulations for data destruction. The Mechanism 1 is lighter than other units in the industry, which weigh thousands of pounds since they also reduce the non-data bearing materials to 2 mm particle size.

The mechanism 1 has unique identification tags 10 for each solid-state printed circuit board (PCB) data-bearing device 20 placed on the side opposite to the data-bearing components 30 so it will remain in place after separation and destruction of the data-bearing components 30. The solid-state printed circuit board (PCB) after separation of the data-bearing components will then be stored as non-shredded solid-state PCBs 25 with unique identification tag 10 in system 300 for secure containment until verification.

The mechanism 1 uses a computer system 100 with secure and proprietary database 310 and scanner 320 for scanning the unique identification tag 10 of each solid-state PCB data-bearing device 20.

The mechanism 1 will have a moving track 700 to hold and move the solid-state PCB data-bearing device 20. The mechanism 1 is designed for channeling 700, separation 90, and collection of data-bearing components 30 from the solid-state PCB and the destruction of data-bearing components 30 by reducing components 30 to 2 mm particle size or smaller to become particles 35.

The mechanism 1 will have a screening system 80 to ensure accurate particle size after destruction and an internal particle collection system 450 and a system 300 for secure containment of non-shredded solid-state PCBs 25 with unique identification tag 10 after separation and destruction of their data-bearing components 30 until verification. The mechanism 1 and system, in the preferred embodiment has an air filtration system 400 to preserve air quality where the Solid-State Stripper Mechanism 1 is located when it is in use.

Steps for Solid-State Stripper System

Step 1 is where the solid-state printed circuit board (PCB) data-bearing device 20 has a unique identification tag 10 placed on the side opposite to the data-bearing components 30 so it will remain in place after separation and destruction of the data-bearing components 30.

Step 2 is the use of computer system 100 with secure and proprietary database 310 and scanner 320 for scanning the unique identification tag 10 of each solid-state PCB data-bearing device 20 which becomes non-shredded solid-state PCBs 25 after separation of the data-bearing components. It will then be tracked and stored as non-shredded solid-state PCBs 25 with unique identification tag 10 in system 300 for secure containment until verification.

Step 3 is the placement of the tagged and scanned solid-state PCB data-bearing device 20 into the moving track 700 to hold and move the solid-state PCB data-bearing device 20 into the Solid-State Stripper Mechanism 1.

Step 4 is the activation of the mechanism for channeling 700 and separation 90 of data-bearing components 30 from the solid-state PCB 20.

Step 5 is the activation of the mechanism 1 for destruction of data-bearing components 30 by reducing the components 30 to 2 mm particle size or smaller particles 35 using a grinder 70.

Step 6 is use of the screening system 80 to ensure accurate particle size after destruction.

Step 7 is the internal particle collection system 450 that collects particles 35, 2 mm particle size or smaller, that have moved through the screening system 80.

Step 8 is the system for secure containment 300 of non-shredded solid-state PCBs 25 with unique identification tag 10 after separation and destruction of their data-bearing components 30 until verification.

Step 9 is the use of the air filtration system 400 to preserve air quality where the Solid-State Stripper Mechanism is located when it is in use.

### Advantages

By following the Solid-State Stripper Mechanism's process, the organization can be confident that the data-bearing components of the solid-state PCB data-bearing device have been reduced to a particle size of 2 mm or smaller rendering the data unusable. This alleviates the potential problem of the organization damaging their brand due to leaks of secure data onto the global network. It helps to solve an insider threat in cybersecurity. It saves the organization time and effort in marketing and answering claims in the legal system regarding secure data breaches. It helps the organization meet cybersecurity regulations and avoid significant fines for non-compliance. This Solid-State Stripper Mechanism is time and energy efficient while promoting efficient recycling processes with less intermixing of components' raw material. This Solid-State Stripper Mechanism is portable, intended for use within the customer's secure datacenter or enterprise facility, and adaptable for changes in characteristics of solid-state devices and changes in cybersecurity regulations for data destruction.

Additionally: Any organization that wants to securely remove not only digital information, but also immediately destroy mechanical information such as a shape and size of a design by reducing the components to 2 mm or smaller particle size. Any organization that wants to perform separation of components from PCBs or other boards. Any organization that wants to use a screening system to ensure accurate particle size. Any organization that wants to use a secure internal collection system.

Also, it can create: A new method for channeling, separation and collection of data-bearing components from solid-state PCBs within the Solid-State Stripper Mechanism.

### CONCLUSION

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A device of destroying data on a solid-state PCB device:
a mechanism that receives solid-state PCB device that are tagged with an unique identification tag where the solid-state device has data-bearing components, scanning the unique identification tag using a scanning means, removing the data-bearing components, and reducing the data-bearing components to particles.

2. The device according to claim 1 where the particles are reduced to a size of 2 mm particle size or smaller.

3. The device according to claim 1 having an internal particle collection system.

4. The device according to claim 1 having an air filtration system.

5. The device according to claim 1 having screening system.

6. The device according to claim 1 having a moving track.

7. The device according to claim 6 where the moving track holds and moves the solid-state PCB data-bearing device.

8. The device according to claim 1 where the device is portable.

9. The device according to claim 1 with a secure containment for solid-state PCB device after the data-bearing components have been removed with the unique identification tag until verification.

10. A process to destroy data comprising;
tagging a solid-state PCB device that has data-bearing components with unique identification tags;
having a mechanism that receives solid-state PCB devices;
scanning the tag using a scanning means;
removing the data-bearing components; and
reducing the data-bearing components to particles.

11. The system according to claim 10 where the particles are reduced to a size of 2 mm particle size or smaller and use of the screening system to ensure accurate particle size after destruction.

12. The system according to claim 10 having an internal particle collection system.

13. The system according to claim 10 having an air filtration system.

14. The system according to claim 10 having screening system.

15. The system according to claim 10 having a moving track.

16. The system according to claim 10 where the moving track holds and moves the solid-state PCB data-bearing device.

17. The system according to claim 10 where the device is portable.

18. The system according to claim 10 with a secure containment for solid-state PCB device after the data-bearing components has been removed with unique identification tag until verification.

19. The system according to claim 10 providing reconciliation and tracking of the unique identification tags using a secure and proprietary database and scanner for scanning the unique identification tag of each solid-state PCB data-bearing device.
